(19) United States
(12) Patent Application Publication
(10) Pub. No.: US 2006/0099836 A1
(43) Pub. Date: May 11, 2006

(54) Electrical connector

(76) Inventor: Yi-Tse Ho, Tainan Hsien (TW)

Correspondence Address: MOLEX INCORPORATED, 2222 WELLINGTON COURT, LISLE, IL, 60532, US

(21) Appl. No.: 11/267,883

(22) Filed: Nov. 4, 2005

(30) Foreign Application Priority Data
Nov. 8, 2004 (TW) 93217822

(51) Int. Cl. H01R 12/00

(52) U.S. Cl. 439/74

(57) ABSTRACT

An electrical connector includes an insulating housing and a plurality of conductive terminals. The insulating housing includes a body and a connection portion. The body has a first face and a second face opposite to each other. The connection portion projects outwardly from the first face, whereas the second face is formed with a recessed portion that is recessed into the body. The recessed portion is formed with a first stepped face proximate to the second face, and a second stepped face farther from the second face than the first face. The insulating housing is further provided with a plurality of terminal passages communicating a connection face and the recessed portion. Each of the conductive terminals includes a contact portion exposed from the connection face, a coupling portion disposed at the recessed portion, and a positioning portion connecting the contact portion and the coupling portion and disposed to generate interference with a corresponding one of the terminals passages such that the contact portions of the conductive terminals respectively secured in the terminal passages located at the first stepped face and the second stepped face are different in position.

### FIELD OF THE INVENTION

This invention relates to an electrical connector, and more particularly, to an electrical connector having easy to assembly staggered terminals.

### BACKGROUND OF THE INVENTION

In view of the increasingly improved operating efficiency of central processing units of electronic products, data transmission speeds of peripheral equipment have to be increased as well. Particularly, standard peripheral equipment, such as hard disks, optical disks, etc., are required to have faster data transmission speeds. Therefore, interfaces, which can transmit data at high speeds, have gradually become mainstream interfaces for electrically connecting electronic products and peripheral equipment.

An electrical connector, such as those meeting the SerialATA specification, are designed to supply electric currents having different voltage values while being capable of transmitting electric signal data at high speeds, and can even be coupled to or detached from peripheral equipment when an electronic device is in an “on” state, achieving the so-called “hot plugging” effect.

However, in order to achieve the hot plugging function, the arrangement of conductive terminals in an electrical connector is generally modified to have different lengths. That is, for a conductive terminal dedicated to grounding, the length of its contact portion, which is disposed to electrically contact a corresponding electrical connector, is longer than that of contact portions of other conductive terminals that are dedicated to signal transmission. Thus, during the process of inter-engagement of the electrical connector and the corresponding electrical connector, the grounding portion will achieve electrical connection first. On the contrary, during the process of disengagement of the electrical connector from the corresponding electrical connector, the grounding portion will be the last to achieve electrical disconnection, thereby ensuring stability of data transmission.

Since conductive terminals of at least two different lengths are required, in the case of the currently adopted manufacturing process of using a machine to assemble the same to an insulating housing by “strip insertion,” it is necessary to punch long and short conductive terminals from the same material strip. Therefore, during the punching process, punching machinery has to be programmed to automatically perform replacement and adjustment of punching molds when the length of the terminals on the material strip varies. Hence, compared with continuous punching of conductive terminals of the same length, it takes time to replace and adjust the molds, thereby increasing the overall punching time relatively and reducing the manufacturing efficiency considerably. On the other hand, to meet the requirement of punching conductive terminals of different lengths, in the design of molds, the structure of such molds will be more complicated than those for punching conductive terminals of the same length, thereby increasing manufacturing costs.

Furthermore, in view of market demands for lightweight and compact electronic products or peripheral equipment, how to minimize the area of a circuit board occupied by an electrical connector while ensuring a certain degree of structural strength and meeting the aforesaid functional requirement of using conductive terminals of different lengths is also a big challenge in design.

### SUMMARY OF THE INVENTION

Therefore, an object of this invention is to provide an electrical connector that can meet the same functional requirement without using conductive terminals of different lengths.

Another object of this invention is to provide an electrical connector designed to occupy a small area of a circuit board while maintaining sufficient structural strength.

Accordingly, an electrical connector of this invention is electrically connected to a circuit board to provide connection with a corresponding electrical connector, the electrical connector including an insulating housing and a plurality of conductive terminals.

The insulating housing includes a body and a connection portion connected to the body. The body has a first face and a second face opposite to each other. The connection portion is formed with a connection face projecting outwardly from the first face, whereas the second face is formed with a recessed portion that is recessed into the body. The recessed portion is formed with a first stepped face proximate to the second face, and a second stepped face farther from the second face than the first stepped face. The insulating housing is further provided with a plurality of terminal passages communicating the connection face and the recessed portion. Each of the conductive terminals includes a contact portion exposed from the connection face for electrical connection with a corresponding electrical connector, a coupling portion disposed at the recessed portion for electrical connection with the circuit board, and a positioning portion connecting the contact portion and the coupling portion and disposed to generate interference with a corresponding one of the terminal passages such that the positions of the contact portions of the conductive terminals respectively secured in the terminal passages located at the first stepped face and the second stepped face relative to the body are different.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is an exploded perspective view illustrating the structure of a preferred embodiment of an electrical connector according to this utility model in assembly;

FIG. 2 is an exploded perspective view taken from another angle, showing some components of the preferred embodiment in assembly;

FIG. 3 is a perspective view illustrating the outer appearance of the preferred embodiment after assembly, and its assembly with a corresponding electrical connector; and

FIG. 4 is a top view illustrating the major dimensions of the preferred embodiment.

### DETAILED DESCRIPTION OF THE DISCLOSED EMBODIMENTS

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

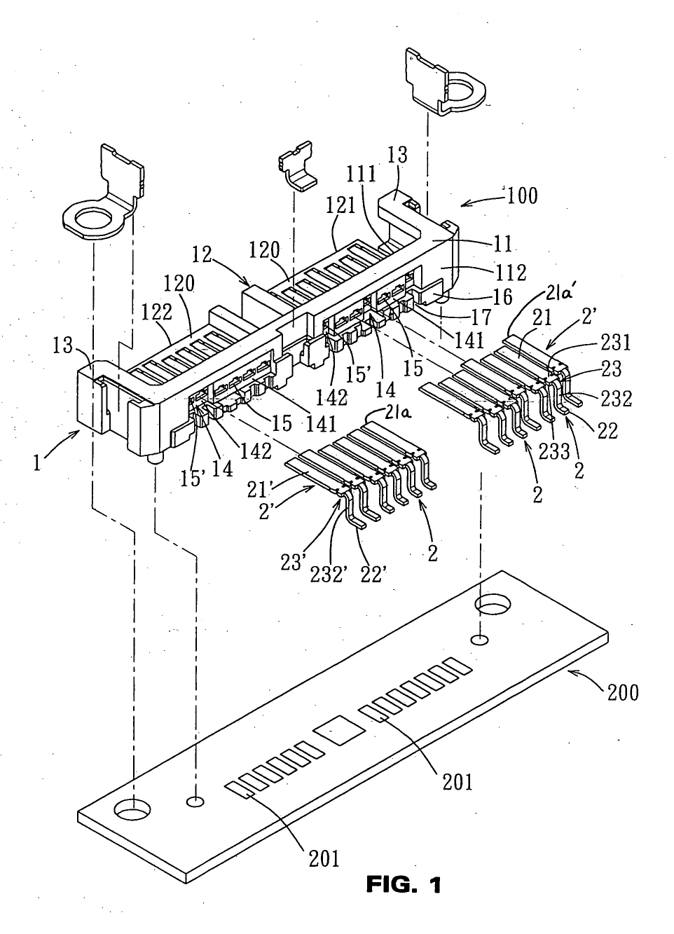

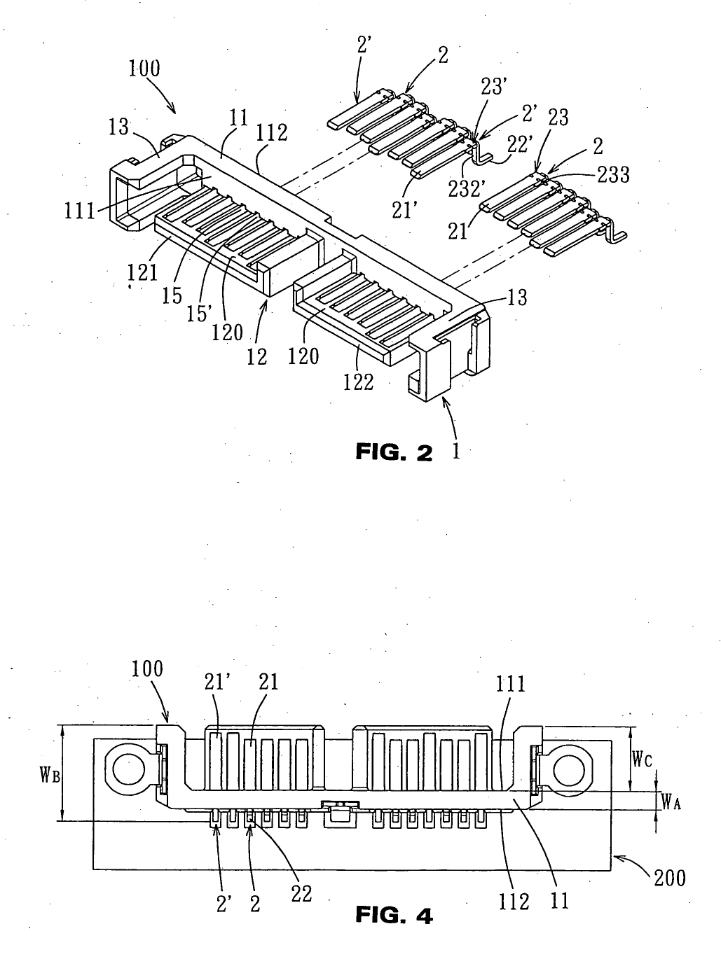

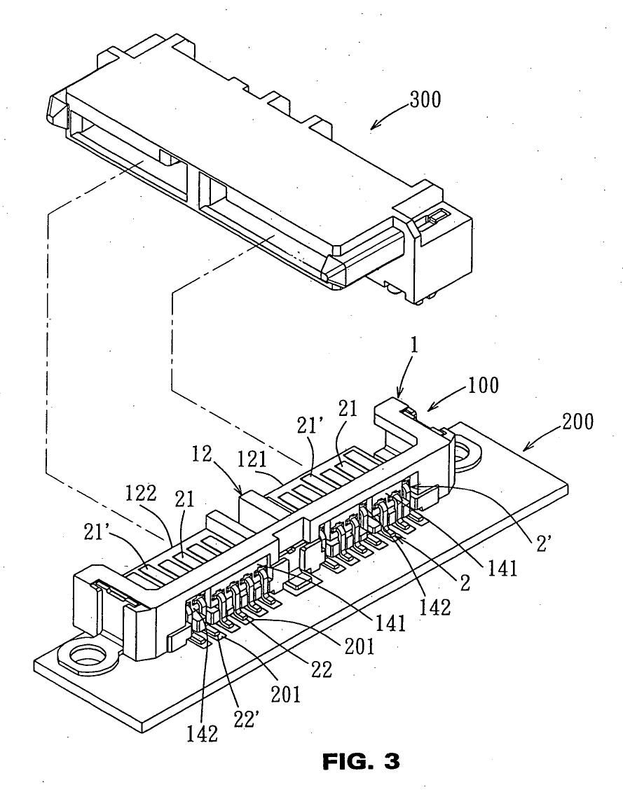

Referring to FIGS. 1 to 3, one preferred embodiment of an electrical connector 100 according to this invention is electrically connected to a circuit board 200 of an optical disk drive (not shown), and can be connected to a corresponding electrical connector 300 (see FIG. 3). The corresponding mating electrical connector 300 may be disposed on an electronic device (not shown) of a computer. The electrical connector 100 includes an insulating housing 1 and a plurality of conductive terminals 2.

The insulating housing 1 includes a transversely extending body 11. The body 11 has a first face 111 and a second side face 112 opposite to each other. The body 11 is provided with an outwardly extending connection portion 12 at a middle position of the first face 111 for coupling with the corresponding mating electrical connector 300. An upwardly facing side of the connection portion 12 forms a connection face 120. Moreover, the first face 111 has guiding portions 13 extending respectively from two opposite ends and in the same direction as the direction of extension of the connection portion 12 to relatively guide the corresponding electrical connector 300 in a coupling direction. In this embodiment, the connection portion 12 can be divided into a power connection region 121 and a signal connection region 122.

In addition, the second face 112 of the body 11 is formed with a recessed portion 14 that is recessed into the body 11. An inner surface of the recessed portion 14 is formed into steps to constitute a plurality of first stepped faces 141 closer to the second face 112 and a plurality of second stepped faces 142 that are more recessed than the first stepped faces 141 and that are farther from the second face 112. The position of the first stepped faces 141 and the second stepped faces 142 in the recessed portion 14 is determined by the position of the conductive terminals 2 (to be described hereinafter). Therefore, the number and position thereof are alterable. The insulating housing 1 is further provided with a plurality of terminal passages 15, 15′ extending through the body 11 to communicate the connection face 120 and the recessed portion 14 such that the terminal passages 15 correspondingly extend therethrough to be located at the first stepped faces 141, whereas the terminal passages 15′ correspondingly extend therethrough to be located at the second stepped faces 142.

The conductive terminals 2, 2′ are correspondingly positioned in the terminal passages 15, 15′. Since the conductive terminals 2, 2′ are identical in structure, in the description to follow, unless otherwise specified, the conductive terminals 2 are exemplified. Each conductive terminal 2 includes a contact portion 21 exposed from the connection face 120 for electrical connection with the corresponding electrical connector 300, a coupling portion 22 exposed from the recessed portion 14 for soldering onto a corresponding solder pad 201 on the circuit board 200, and a positioning portion 23 connected to the contact portion 21 and the coupling portion 22. In this embodiment, the positioning portion 23 has a horizontal section 231 connected to the contact portion 21, and an upright section 232 connected to the coupling portion 22. Two sides of the horizontal section 231 are each provided with a plurality of retaining teeth 233 to generate an interfering retaining action with an inner wall of the corresponding terminal passage 15.

Each conductive terminal 2 is inserted in a direction from the second face 112 to the first face 111 to be positioned in the corresponding terminal passage 15 such that the position of the contact portion 21 is at a distance from the body. The positioning portions 23′ of the conductive terminals 2′ are correspondingly inserted into the terminal passages 15′ in the second stepped faces 142 such that the position of the distal end 21a′ of contact portions 21′ of the conductive terminals 2′ is farther from the body 11 than the distal end 21a of contact portions 21 of the rest of the conductive terminals 2 to result in a difference in position. The conductive terminals 2′ thus function as the aforesaid conductive terminals of longer length and can serve as grounding terminals. Due to the configuration that the first stepped face 141 is closer to the second face 112 of the body 11 than the second stepped face 142, the conductive terminals 2 with the contact portions 21 that are positioned closer to the body 11 have relatively long terminal passages 15 so that the retaining teeth 233 on the positioning portion 23 of the conductive terminal 2 can have a sufficient inner wall to retain, thereby achieving the same effect of positioning between the conductive terminals 2′ having the contact portions 21′ positioned farther from the body 11 and the terminal passages 15′. In addition, the conductive terminals 2, 2′ which are respectively located at the power connection region 121 and the signal connection region 122 can be correspondingly divided into power terminals for transmitting power and signal terminals for transmitting electric signals.

During actual assembly, all the conductive terminals 2 (including 2′) are identical in shape and length, and can be formed on a material strip (not shown) in advance by a continuous punching process and assembled to the insulating housing 1 by “strip insertion.” Through the control of assembling equipment (not shown), the entire strip of the plurality of conductive terminals 2 (including 2′) are first inserted together into the corresponding terminal passages 15 (15′), with all the conductive terminals 2 (including 2′) reaching the predetermined positions of the conductive terminals 2. This is the first stage of the insertion operation. Then, the assembly equipment proceeds with the second stage of the insertion operation to insert the remaining conductive terminals 2′, with the exception of the conductive terminals 2, further into the corresponding terminals 15′ to the predetermined positions, finally achieving the assembled state as shown in FIG. 3.

Furthermore, in order that the upright sections 232 of the positioning portions 23 of the conductive terminals 2 will not deviate to the left or right after assembly, the body 11 is formed with a flange 16 at the recessed portion 14 proximate to a lower end, and a plurality of uprightly extending limiting grooves 17 are further provided on the flange 16 for correspondingly retaining the upright sections 232, 232′ of the conductive terminals 2, 2′ therein so as to achieve a limiting action to prevent sidewise deviation thereof, thereby precluding any effect on the corresponding connective positions of the coupling portions 22, 22′ and the solder pads 201 of the circuit board 200.

Referring to FIGS. 3 and 4, under the standard of the SerialATA specification, factors affecting strength and circuit board area occupied by the electrical connector 100 after assembly are mainly determined by two dimensions, i.e., widths W_{A} and W_{B} shown in FIG. 4. W_{A} represents the thickness between the first face 111 and the second face 112 of the body 11, the size of which will affect the structural strength of the electrical connector 100, whereas W_{B} represents the distance from an outermost edge of the connection portion 12 to a distal end of the coupling portion 22 of the conductive terminals 2, the size of which will affect the size of the area of the circuit board 200 occupied by the electrical connector 100. Additionally, W_{C} represents the distance the connection portion 12 projects from the body 11, which must be larger than or equal to the length specified by the specification in order to ensure a sufficient distance to permit mutual contact with the corresponding electrical connector 300. Therefore, by virtue of the configuration of the three stepped surfaces formed by the second face 112, the first stepped face 141, and the second stepped face 142 of the body 11, and under the condition that the size of W_{C} is unchanged to comply with the specification, this invention can ensure the effects of structural strength as well as lightweight and compactness at the same time, as can be explained from two aspects.

First, when the size of W_{B} is reduced to design requirements in consideration of the area of the circuit board 200 occupied, it is not necessary to reduce the size of W_{A} at the same time. It will be only necessary to suitably adjust the depth of recess of the first stepped face 141 and the second stepped face 142 relative to the second face 112, which is therefore a relative increase in the size of W_{A} and can enhance the structural strength of the electrical connector 100.

Second, if the size of W_{A} is fixed at a value required by design in consideration of the structural strength of the electrical connector 100, the depth of recess of the first stepped face 141 and the second stepped face 142 relative to the second face 112 can likewise be suitably adjusted such that the coupling portion 22 of the conductive terminal 2 will not project from the second face 112 to an excessive extent, and such that the upright section 232 can be completely disposed in the recessed portion 14, i.e., a relative reduction in the size of W_{B}. Hence, the area of the circuit board 200 occupied by the electrical connector 100 can be further reduced to conform to the design trend toward lightweight and compactness.

In sum, in this invention, by virtue of the three-step surface design of forming the second face 112, the first stepped face 141, and the second stepped face 142 on the body 11 of the insulating housing 1, and by means of the two-stage insertion control of the assembly equipment, the contact portions 21, 21′ of all the conductive terminals 2, 2′ can be made to generate a positional difference to meet functional design requirements, while the conductive terminals 2, 2′ of the same shape, length and size can be used. The purpose is to allow for the use of continuous punching to form the conductive terminals 2, 2′ on the same material strip during manufacture so that it is not necessary to particularly punch conductive terminals of a different length from the material strip at specific positions as described hereinabove, which entails such drawbacks as increased mold replacement time, low punching efficiency, complicated mold design, etc. Although this invention must be used in conjunction with the setting of the assembly equipment for two-stage insertion, since the insertion of the conductive terminals 2, 2′ into the insulating housing 1 is a one-step operation, the increase in time and cost for strip insertion and assembly is comparatively insignificant compared to the time and cost needed for punching conductive terminals of different lengths as mentioned hereinabove, thereby considerably enhancing the manufacturing efficiency of the electrical connector 100 while reducing manufacturing costs. At the same time, by adjusting and changing the depth of recess of the first stepped face 141 and the second stepped face 142 relative to the second face 112, the design requirements as to structural strength as well as lightweight and compactness can be met. Thus, the objects of this utility model can be achieved.

While a preferred embodiment of the invention is shown and described, it is envisioned that those skilled in the art may devise various modifications without departing from the spirit and scope of the foregoing description and the appended claims.

What is claimed is:

1. An electrical connector electrically connected to a circuit board to provide connection with a corresponding electrical connector, the electrical connector comprising:
an insulating housing including a body and an connection portion connected to the body, the body having a first face and a second face opposite to each other, the connection portion projecting outwardly from the first face to form an connection face, the second face being formed with a recessed portion that is recessed into the body, the recessed portion being formed with a first stepped face proximate to the second face, and a second stepped face farther from the second face than the first stepped face, the insulating housing being further provided with a plurality of terminal passages extending through the body to communicate the connection face and the recessed portion; and
a plurality of conductive terminals correspondingly inserted into and positioned in the corresponding terminal passages, each of the conductive terminals including a contact portion exposed from the connection face for electrical connection with the corresponding electrical connector, a coupling portion disposed at the recessed portion for electrical connection with the circuit board, and a positioning portion connected to the contact portion and the coupling portion and disposed to generate interference with a corresponding one of the terminal passages such that the positions of the contact portions of the conductive terminals that are respectively secured in the terminal passages located at the first stepped face and the second stepped face relative to the body are different.

2. The electrical connector as claimed in claim 1, wherein the contact portions of the conductive terminals secured in the terminal passages located at the second stepped face project farther from the body than the contact portions of the conductive terminals secured in the terminal passages located at the first stepped face.

3. The electrical connector as claimed in claim 1, wherein the connection portion of the insulating housing is divided into a power connection region and a signal connection region, the plurality of conductive terminals disposed at the power connection region and the signal connection region being divided correspondingly into a plurality of power terminals for transmitting power and a plurality of signal terminals for transmitting electric signals.

4. The electrical connector as claimed in claim 1, wherein the recessed portion of the insulating housing is formed with a flange extending in a direction farther away from the connection portion, the flange being provided with a plurality of limiting grooves for correspondingly retaining the positioning portions of the conductive terminals therein.

5. An electrical connector, comprising:
an insulating housing including a body, the body having a first face and a second face opposite to each other, the second face being formed with a recessed portion that is recessed into the body, the recessed portion being formed with a first stepped face proximate to the second face, and a second stepped face farther from the second face than the first stepped face, the insulating housing being further provided with a plurality of terminal passages extending through the body to communicate the connection face and the recessed portion; and
a plurality of conductive terminals correspondingly inserted into and positioned in the corresponding terminal passages, each of the conductive terminals including a contact portion for electrical connection with the corresponding electrical connector, a coupling portion disposed at the recessed portion for electrical connection with the circuit board, and a positioning portion connected to the contact portion and the coupling portion and disposed to generate interference with a corresponding one of the terminal passages such that the positions of the contact portions of the conductive terminals that are respectively secured in the terminal passages located at the first stepped face and the second stepped face relative to the body are different.

6. The electrical connector as claimed in claim 5, wherein the contact portions of the conductive terminals secured in the terminal passages located at the second stepped face project farther from the body than the contact portions of the conductive terminals secured in the terminal passages located at the first stepped face.

7. The electrical connector as claimed in claim 5, wherein the insulating housing is divided into a power connection region and a signal connection region, the plurality of conductive terminals disposed at the power connection region and the signal connection region being divided correspondingly into a plurality of power terminals for transmitting power and a plurality of signal terminals for transmitting electric signals.

8. The electrical connector as claimed in claim 5, wherein the recessed portion of the insulating housing is formed with a flange, the flange being provided with a plurality of limiting grooves for correspondingly retaining the positioning portions of the conductive terminals therein.
